(19) United States
(12) Patent Application Publication
(10) Pub. No.: US 2011/0002250 A1
(43) Pub. Date: Jan. 6, 2011

(54) METHOD AND APPARATUS FOR REDUCING BATTERY CONSUMPTION IN A WTRU UPON ETWS NOTIFICATION

(75) Inventors: Peter S. Wang, East Setauket, NY (US); Jean-Louis Gauvreau, La Prairie (CA); Paul Marinier, Brossard (CA); Shankar Somasundaram, London (GB)

Correspondence Address: VOLPE AND KOENIG, P.C.;DEPT. ICC, UNITED PLAZA, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/605,675

(22) Filed: Oct. 26, 2009

Related U.S. Application Data
(60) Provisional application No. 61/108,662, filed on Oct. 27, 2008.

(51) Int. Cl. G08C 17/00; G08B 1/08

(52) U.S. Cl. 370/311; 340/539.1; 340/539.22

(57) ABSTRACT

A method and apparatus for broadcasting and receiving an emergency indication during an emergency information broadcast. An eNB is configured to broadcast, and a wireless transmit receive unit is configured to receive, a paging signal including a first emergency indication, a set of system information blocks including emergency information and the paging signal without the first emergency indication while broadcasting the system information blocks including the emergency information. The eNB determines a time period for including the first emergency indication in the paging signal has expired.

### CROSS REFERENCE TO RELATED APPLICATIONS

This application claims the benefit of U.S. Provisional Application No. 61/108,662, filed on Oct. 27, 2008 which is incorporated by reference as if fully set forth.

### FIELD OF INVENTION

This application is related to wireless communications.

### BACKGROUND

The Third Generation Partnership Project (3GPP) has initiated the Long Term Evolution (LTE) program to bring new technology, new network architecture, new configurations and new applications and services to wireless networks in order to provide improved spectral efficiency and faster user experiences.

FIG. 1 shows an overview of an Evolved Universal Mobile Telecommunications System (UMTS) Terrestrial Radio Access Network (E-UTRAN) 100 in accordance with the prior art. As shown in FIG. 1, E-UTRAN 100 includes three eNodeBs (eNBs) 102, however, any number of eNBs may be included in E-UTRAN 100. The eNBs 102 are interconnected by an X2 interface 108. The eNBs 102 are also connected by an S1 interface 106 to the Evolved Packet Core (EPC) 104 that includes a Mobility Management Entity (MME) 112 and a Serving Gateway (S-GW) 110.

In an LTE network, system information (SI) is information that is broadcast within a cell and provides information about configurations and parameters that are common to at least some of the wireless transmit receive units (WTRUs) in the cell. System information messages may include parameters such as network identification, neighbouring cells, channel availability and power control requirements, for example.

In an LTE network, system information is broadcast in modification periods. The modification period is a specific time period. When system information is updated, an update notification is broadcast during a modification period to a WTRU. In the following modification period, the updated system information is broadcast.

An LTE network may also include a severe earthquake and tsunami warning service (ETWS) or other public warning services (PWS). The ETWS or PWS may warn wireless telephone users of an imminent or nearby man-made or natural disaster. The ETWS service may use the SI services to warn users of impending disaster.

In the LTE radio access network, ETWS information is distributed via a system information broadcast. ETWS information may include a warning notification, which may be classified into one of two types, depending on the purpose and urgency of the notification. The first type of notification is called the primary notification, and is broadcast in a system information block (SIB), such as SIB-10, for example. This type of notification delivers the most important information about the approaching threat. Once a wireless transmit receive unit (WTRU) receives notification that a primary notification is present, it immediately reads the primary notification before reading any other SIB.

The second type of notification is called secondary notification. This notification may be carried in another SIB, such as SIB-11, for example. The secondary notification may deliver additional information, such as instructions as to what the user may do and where the user may get help. The secondary notification is broadcast as long as the emergency lasts. If the secondary notification is present, the WTRU will read this notification immediately after reading the primary notification. If the secondary notification is scheduled, the WTRU checks a value tag in the SIB carrying the secondary notification to see it if the WTRU has already received the secondary notification or if there is a new, unreceived notification.

Prior to reading the primary and secondary notifications, the WTRU may receive a paging message. In the paging message, there is an ETWS-indication that serves to indicate to the WTRU that an ETWS broadcast is turned on. Once the indication is received by the WTRU, it will continually check the value tag in the SIB carrying the secondary notification to detect an information update. This continual checking of the value tag may cause a drain on the WTRU battery. Furthermore, when the ETWS warning indication is on, the WTRU may not have the opportunity to recharge its battery power. As the WTRU may need to remain active for other emergency communications during the ETWS, there is a need for saving power in the WTRU.

The ETWS primary notification may also need periodic updates when, for example, an earthquake induces a tsunami or a hurricane triggers highway destruction. Accordingly, it would be desirable to have a method for SIB update notification reception while reducing power consumption of the WTRU during ETWS notification.

### SUMMARY

A method and apparatus for broadcasting and receiving an emergency indication during an emergency information broadcast for WTRU power saving are disclosed. This may include broadcasting a paging signal including a first emergency indication, a plurality of system information blocks including emergency information, and the paging signal without the first emergency indication while broadcasting the system information blocks including the emergency information. The eNB and/or WTRU may determine a time period for the first emergency indication in the paging signal to expire.

The initial emergency indication may include a first set of values. Subsequent indications may include a second set of values representing an emergency information update. Each set of values may be an emergency paging radio network temporary identifier (EP-RNTI) or an information element (IE).

### BRIEF DESCRIPTION OF THE DRAWINGS

A more detailed understanding may be had from the following description, given by way of example in conjunction with the accompanying drawings wherein:

FIG. 1 shows an overview of an Evolved Universal Mobile Telecommunications System (UMTS) Terrestrial Radio Access Network (E-UTRAN) 100 in accordance with the prior art;

FIG. 2 shows an example wireless communication system including a plurality of WTRUs and an eNB;

FIG. 3 is a functional block diagram of a WTRU and the eNB of FIG. 2;

FIG. 4 shows a paging message in accordance with an embodiment;

FIG. 5 shows a signaling diagram of an active ETWS system in accordance with an embodiment;

FIG. 6 shows a signaling diagram of an ETWS broadcast in accordance with an embodiment;

FIG. 7 shows a signaling diagram of an ETWS information update in accordance with an embodiment;

FIG. 8 shows a paging message in accordance with another embodiment;

FIG. 9 shows a paging message in accordance with an alternative embodiment; and

FIG. 10 shows a method of emergency information update in accordance with another alternative embodiment.

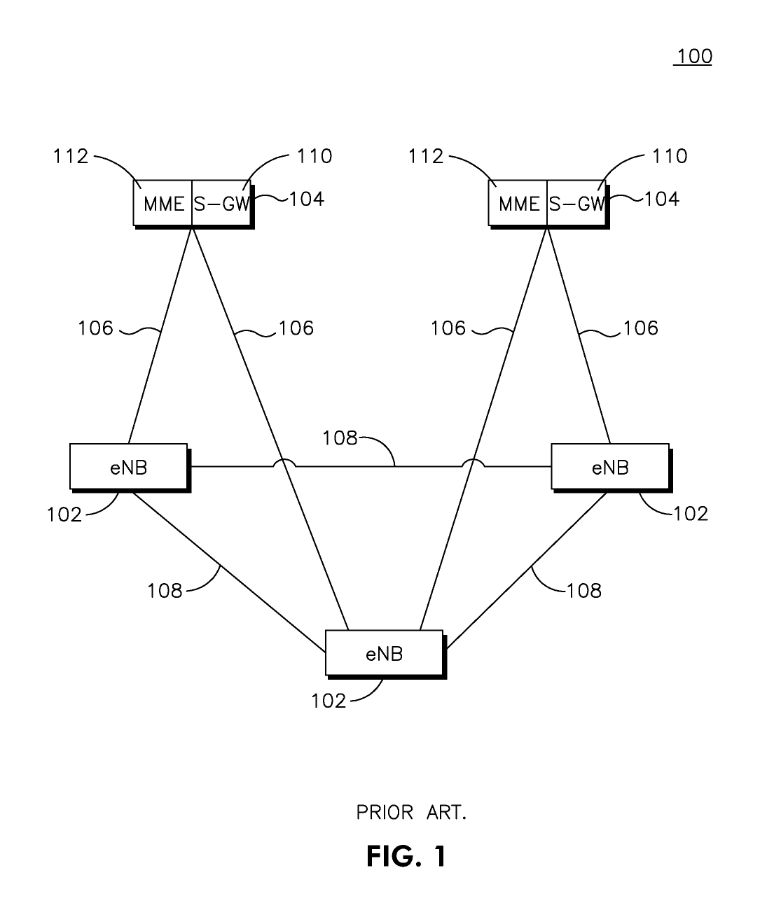

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

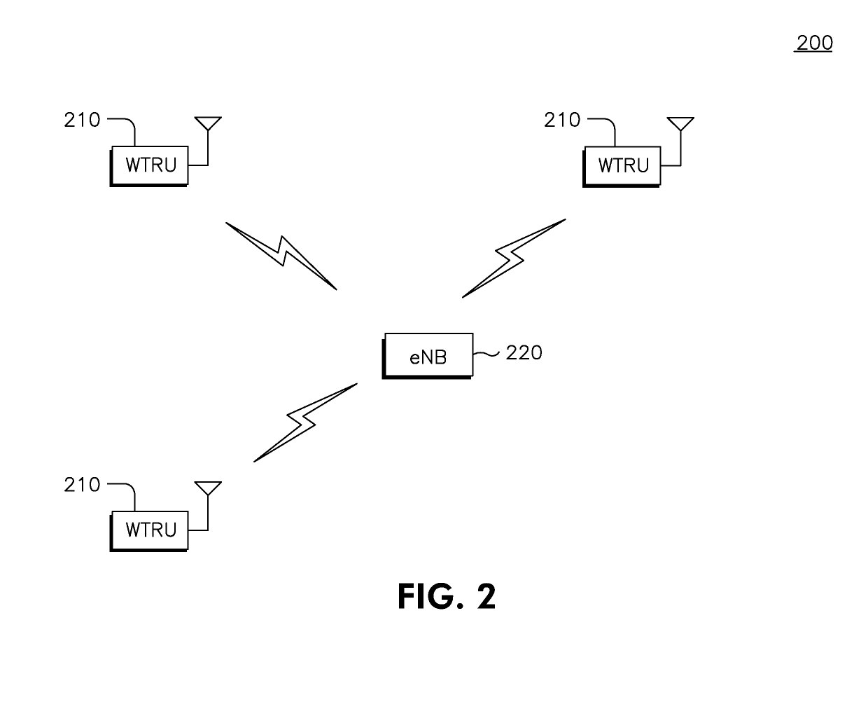

FIG. 2 shows a wireless communication system 200 including a plurality of WTRUs 210 and an e Node B (eNB) 220. As shown in FIG. 2, the WTRUs 210 are in communication with the eNB 220. Although three WTRUs 210 and one eNB 220 are shown in FIG. 2, it should be noted that any combination of wireless and wired devices may be included in the wireless communication system 200.

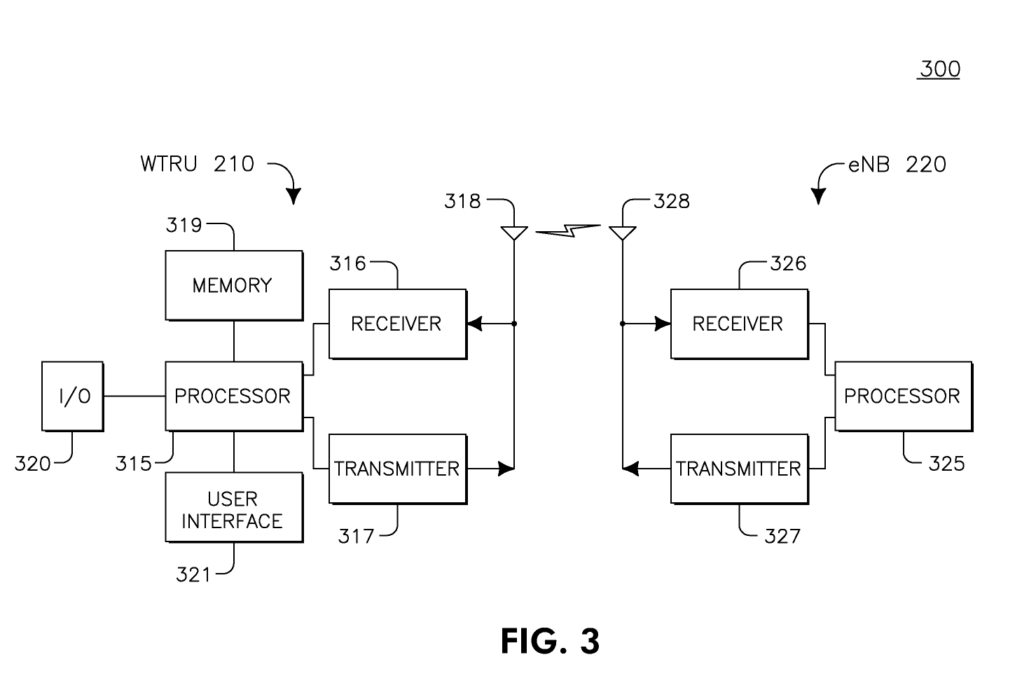

FIG. 3 is a functional block diagram 300 of a WTRU 210 and the eNB 220 of the wireless communication system 200 of FIG. 2. As shown in FIG. 2, the WTRU 210 is in communication with the eNB 220. The WTRU 210 is configured with to receive system information updates and is ETWS capable.

In addition to the components that may be found in a typical WTRU, the WTRU 210 includes a processor 315, a receiver 316, a transmitter 317, and an antenna 318. The WTRU 210 may also include a user interface 321, which may include, but is not limited to, an LCD or LED screen, a touch screen, a keyboard, a stylus, or any other typical input/output device. The WTRU 210 may also include memory 319, both volatile and non-volatile as well as interfaces 320 to other WTRU's, such as USB ports, serial ports and the like. The receiver 316 and the transmitter 317 are in communication with the processor 315. The antenna 318 is in communication with both the receiver 316 and the transmitter 317 to facilitate the transmission and reception of wireless data.

In addition to the components that may be found in a typical eNB, the eNB 220 includes a processor 325, a receiver 326, a transmitter 327, and an antenna 328. The receiver 326 and the transmitter 327 are in communication with the processor 325. The antenna 328 is in communication with both the receiver 326 and the transmitter 327 to facilitate the transmission and reception of wireless data. The eNB 220 is configured to process and transmit system information in system information blocks, as is further configured to operate in an ETWS environment.

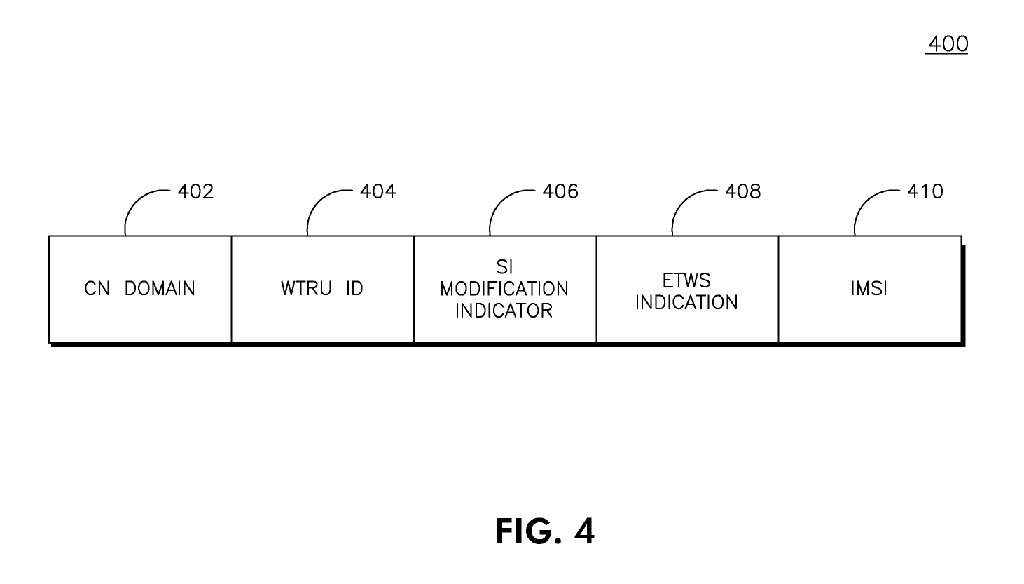

FIG. 4 shows a paging message 400 in accordance with an embodiment. The paging message 400 includes a core network domain (CN-domain) field 402. The CN-domain field 402 includes an identifier of the source network that is sending the paging message 400. The paging message 400 includes a WTRU identity field 404. The WTRU identity field 404 includes an identifier of the target WTRU that is to receive the paging message 400. The paging message 400 includes an international mobile subscriber identifier (IMSI) 410, which is a unique identifier for the user. Optionally, the paging message 400 includes an SI modification indicator 406 and an ETWS-notification 408. If the SI modification indicator 406 is set to “TRUE”, the WTRU may determine that the WTRU may receive updated system information in the next modification period. If the ETWS-indication 408 is set to “TRUE”, the WTRU may determine that the ETWS system is active.

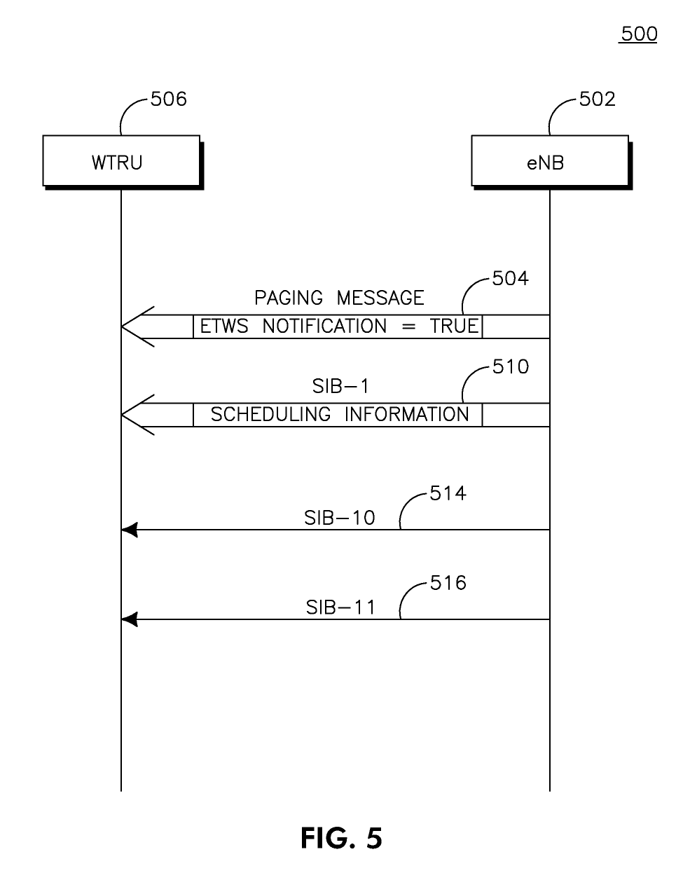

FIG. 5 shows a signaling diagram of an active ETWS system 500 in accordance with an embodiment. The eNB 502 sends a paging message 504 to the WTRU 506. In the paging message 504, the ETWS notification field 508 is set to true. The WTRU 506, after reading the paging message 504 with the ETWS indication field 508 set to TRUE, may immediately read SIB-1 510. SIB-1 510 includes scheduling information 512 for SIB-10 514, and SIB-11 516. The WTRU 506 may read the scheduling information 512 and then immediately read SIB-10 514 and/or SIB-11 516.

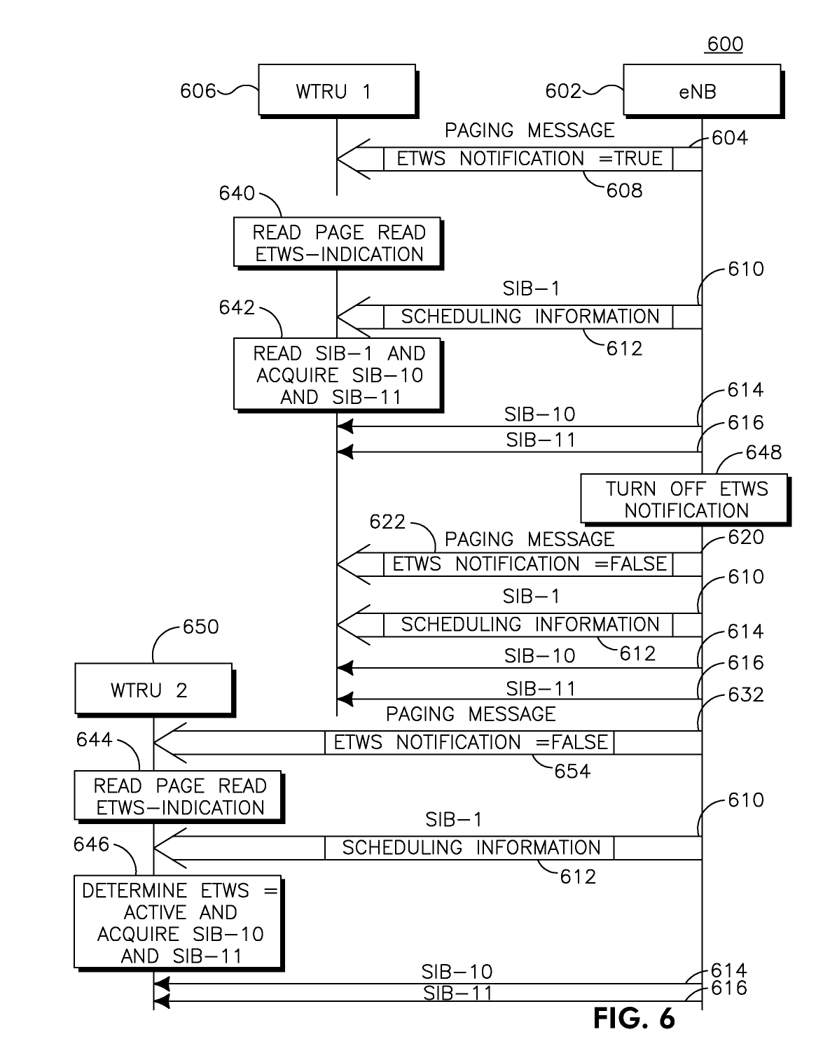

FIG. 6 shows a signaling diagram of an ETWS broadcast 600 in accordance with an embodiment. An eNB 602 broadcasts a first paging message 604 to a first WTRU 606. In the first paging message 604, the ETWS-indication field 608 is set to TRUE. At block 640, the first WTRU 606 may read the first paging message 604 and the ETWS-indication field 608. The eNB 602 broadcasts SIB-1 604. At block 642, the first WTRU 606 immediately receives and reads SIB-1 610, which includes scheduling information 612 for SIB-10 614 and SIB-11 616, and acquires both SIB-10 614 and SIB-11 616. At block 648, the eNB 602 may then turn off the ETWS-indication by setting the ETWS-indication field 608 to “FALSE”.

The eNB 602 may then broadcast a second paging message 620 with the ETWS-indication field 622 set to FALSE. However, SIB-1 610, SIB-10 614 and SIB-11 616 may be rebroadcast without any changes.

A second WTRU 650 may be powered on after the first paging message 604 has been transmitted. At block 644, the second WTRU 650 reads the second paging message 652 that includes an ETWS-indication field 654 set to FALSE. The eNB 602 rebroadcasts SIB-1 610 that includes scheduling information 612. At block 646 the second WTRU 650 receives SIB-1 610, reads the scheduling information 612 for SIB-10 614 and/or SIB-11 616, and may implicitly determine that the ETWS system is active because SIB-1 610 includes the scheduling information 612. The second WTRU 650 acquires SIB-10 614 and SIB-11 616 based on the scheduling information 612 in SIB-1 610.

An eNB initially sets an ETWS-notification field to TRUE when the ETWS system is first activated. The eNB will, after a certain time period, then set the ETWS-notification field to FALSE. The eNB will reset the ETWS-notification field to TRUE when there is an update to the information in SIB-10 or SIB-11.

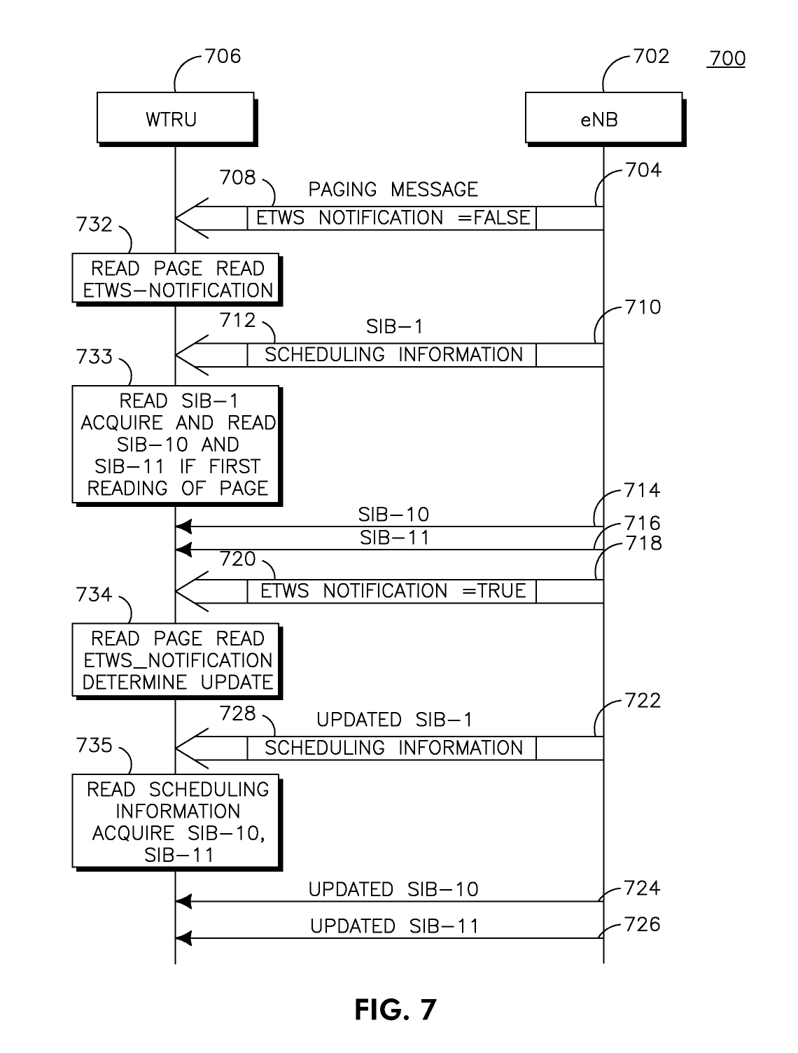

FIG. 7 shows a signaling diagram of an ETWS information update 700 in accordance with an embodiment. The eNB 702 broadcasts a paging message 704 to the WTRU 706. The ETWS-indication field 708 in the paging message 704 is set to FALSE. At 732, the WTRU 706 reads the paging message 704 and the ETWS-indication field 708. The WTRU 706 receives SIB-1 740 from the eNB 702 and, at block 733, the WTRU 706 reads SIB-1 710 and acquires SIB-10 714 and SIB-11 716 if the WTRU 706 is reading SIB-1 710 for the first time. Otherwise, the WTRU 706 determines that there are no SIB updates as the ETWS-indication 708 is FALSE, and does not need to acquire SIB-10 714 and/or SIB-11 716.

The WTRU 706 receives a second paging message 718 that includes an ETWS-indication field 720 set to TRUE. At block 734 the WTRU reads the paging message 718 and the ETWS-indication field 720 and determines that the information in SIB-10 and/or SIB-11 has been updated. The WTRU receives an updated SIB-1 728, and, at block 735, the WTRU 706 reads SIB-1 722 with the new scheduling information 728 and acquires the updated information in SIB-10 724 and SIB-11 726.

After a WTRU initially reads SIB-10 and SIB-11, it does not need to read them again unless it receives a paging message with the ETWS-notification field set to TRUE. This may save power in the WTRU, as it may need to perform fewer functions to ensure that it reads updated emergency information.

As shown herein, the ETWS-indication field includes a Boolean operator. However, the ETWS-indication field may include any value, or string of values, that serves to indicate that the ETWS system is active, or that emergency information has been updated. For example, the ETWS-indication field may include information elements (IEs) and/or integer values.

The time period that the ETWS-indication field contains a value that represents that the ETWS system is active, or indicates an update to the emergency information, may be defined by a number (n) of radio resource control (RRC) modification periods (MPs). For example, the time may equal n×MP, where n can be pre-determined or can be signaled to the WTRU by the eNB. It may be included in SIB-1 or SIB-10, for example.

The time period may also be determined by the length of SIB-11, for example, the number of SIB-11 segments, the cell transmission bandwidth, (the larger the cell-BW, the smaller the n value is), or a minimum number M, where M may be, for example, 16. A WTRU may read a paging message with the ETWS-notification such that n=M div “modificationPeriodCoeff”, where the “modificationPeriodCoeff” is broadcast in a system information block, such as SIB-2, for example, and M is predetermined or determined by the network and signaled to the WTRU in another system information block, such as SIB-1 or SIB-10. The eNB may stop sending the ETWS-indication in the paging messages at least one MP before a SIB-11 update is broadcast, regardless of the value of n.

Each time SIB-11 changes, the WTRU may assume that SIB-10 also changes. The WTRU may acquire both SIB-11 and SIB-10. Once the SIB-10 is acquired the WTRU will not check SIB-10 until the SIB-11 update indication is received.

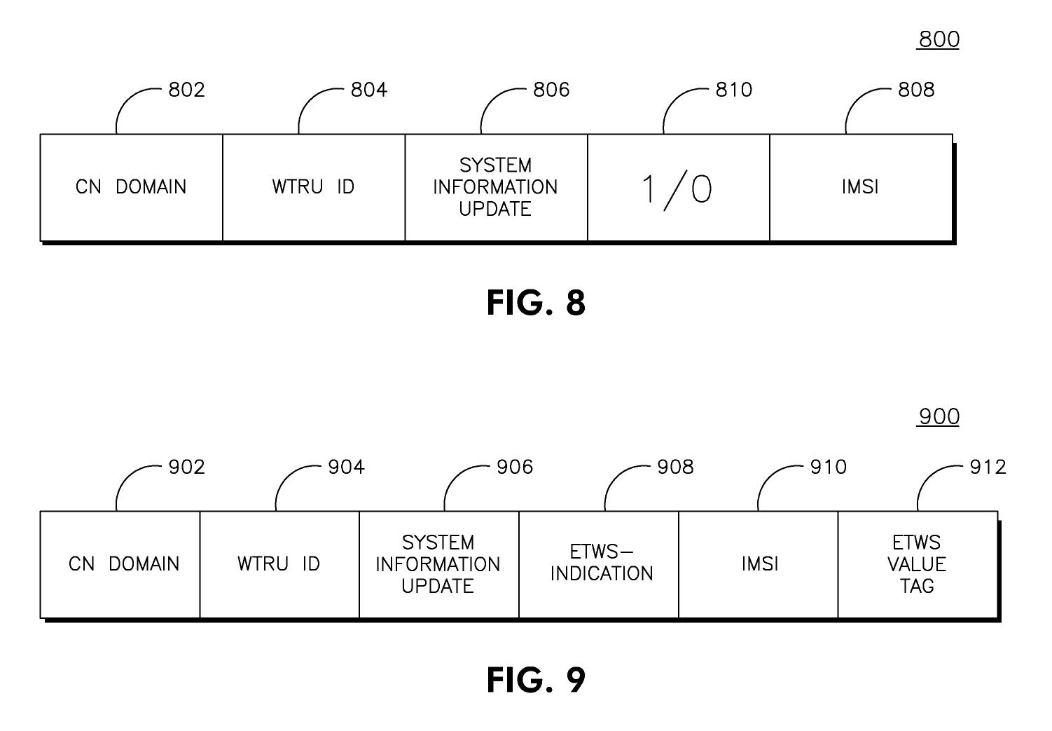

In another embodiment, the ETWS-indication field may contain any one of a multiple of values. A particular value may indicate a particular version of the emergency information. FIG. 8 shows a paging message 800 in accordance with another embodiment. The paging message 800 includes the core network domain field 802, the WTRU identity field 804, the system information update field 806 and the IMSI field 808. The ETWS-indication field 810 may be set to “1” or “0”. A “1” may indicate a current version of the emergency information contained in a system information block, such as SIB-10 or SIB-11, for example. When the value of ETWS-indication field 810 changes to a second value, such as “0”, for example, it may act as a signal that an update of the emergency information is available. Once the WTRU has read the initial version of the emergency information, it may stop reading and checking the SIBs for updates. The WTRU may only monitor the paging message 800 pertaining to its relevant radio resource control (RRC) state (RRC_Idle or RRC_Connected). When the value of the ETWS-indication field 810 changes, the WTRU will then start to acquire the SIB that includes the emergency information. This may save a significant amount of processing power spent on acquiring the SIB.

The number of values used in the ETWS-indication field 810 may be large enough to indicate a change in multiple SIBs. For example, a value of “1” may indicate a change in SIB-11 and a value of “2” may indicate a change in SIB-10. Alternatively, a change in the value in the ETWS-indication field 810 may indicate an update of emergency information in general, and the WTRU may read both SIB-10 and SIB-11 for updates when the value of the ETWS-indication field 810 changes, or when it is set to a particular value.

FIG. 9 shows a paging message 900 in accordance with an alternative embodiment. The paging message 900 includes a CN-domain field 902, a WTRU ID field 904, an SI update field 906, an ETWS-indication field 908, and IMSI field 910 and an ETWS-value tag field 912. The ETWS-value tag may be updated each time the emergency information in a SIB is updated. If a WTRU receives the paging message 900 with the ETWS-indication field 908 set to TRUE, and the ETWS-value tag 912 has not changed since the last emergency event, the WTRU may not monitor the SIBs that include the emergency information. If the ETWS-value tag 912 has changed, then WTRU may reacquire the SIBs that include the emergency information, such as SIB-10 and SIB-11. The ETWS-value tag 912 may be as small as two (2) bits.

Use of the ETWS-value tag 912 may allow the WTRU to monitor only the paging message 900 during paging occasions in an emergency period. This may save considerable power, as the WTRU may not monitor a SIB during the emergency period. The ETWS-indication field 908 may be set to TRUE for several hours with few or no updates for both primary and secondary notification. The paging message 900 may be sent regularly and frequently to ensure that all WTRUs get the emergency notification.

Rather than putting more information in a paging message, the SIBs that include the emergency information may also include value-tags that may indicate versions of the emergency information. For example, a value tag in SIB-1 can be extended to include multiple values. There may be at least one value tag that indicates change in emergency information in general. Alternatively the SIB may include multiple value tags, one for each SIB that carries emergency information, such as SIB-10 and SIB-11, for example. The WTRU may read those value tags to check whether SIB-10 and/or SIB-11 has been updated

In another alternative embodiment, an Emergency Paging Radio Network Temporary Identification (EP-RNTI) may be used to signal and monitor updates for SIBS carrying emergency information, such as updates of SIB-10 and SIB-11, for example. The WTRU may acquire the EP-RNTI from one of the SIBs or from the paging message that includes the ETWS-indication. The WTRU may monitor the EP-RNTI over the Physical Downlink Control Channel (PDCCH) to receive SIB updates.

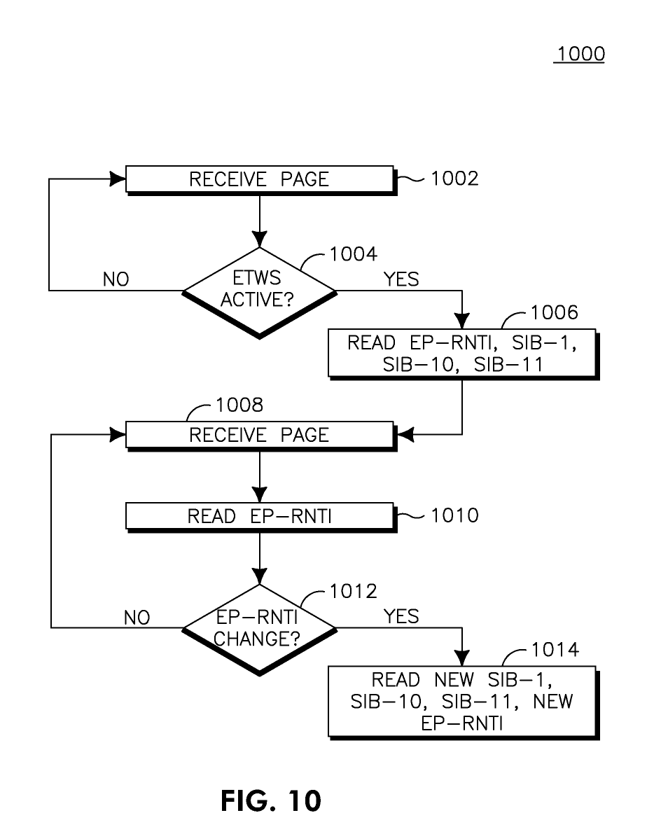

FIG. 10 shows a method of emergency information update 1000 in accordance with another alternative embodiment. At step 1002, the WTRU receives a paging message. At step 1004, the WTRU determines if the ETWS system is active. If not, the WTRU returns to step 1002 to receive the next paging message. If, at step 1004, the WTRU determines that ETWS is active, the WTRU, at step 1006, reads at least one of the EP-RNTI, SIB-1, SIB-10 and SIB-11. At step 1008, the WTRU receives the next paging message. At step 1010, the WTRU reads the EP-RNTI. At step 1012, the WTRU determines if the EP-RNTI has changed. If so, at step 1014, the WTRU may read the updated information with a new EP-RNTI. If not, the WTRU returns to step 10 to read the next paging message.

An EP-RNTI value may be assigned to each SIB update. The WTRU may monitor the EP-RNTI to receive the updated emergency SIB information over the Physical Downlink Control Channel (PDCCH). The EP-RNTI value may be signaled within the SIB that includes the emergency information or within the paging message along with the ETWS-indication.

The network may maintain the paging message with the EP-RNTI for a certain time period. The time period may be long enough so that all WTRUs have had the opportunity to receive the paging information. After the WTRU has acquired the new version of the emergency information, which may be in SIB-11, for example, with the new value of EP-RNTI, it monitors the paging occasions with this new value to determine when to read the SIB for the next update. The network could thus alternate between two values of EP-RNTI.

In yet another alternative embodiment, special paging occasions for emergency information modifications may be defined for monitoring the current EP-RNTI. Each paging occasion ma have a discontinuous reception (DRX) cycle length, T, a paging group number, N, and a special WTRU ID that is acquired by the WTRU with the EP-RNTI. Rather than associating a special P-RNTI value to a certain SIB-11 or SIB-10 contents, as set forth above, a special paging occasion may be associated with emergency information updates. The paging occasion may be defined in terms of a discontinuous reception (DRX) cycle length (T), a number of paging groups within a DRX cycle (N), a number of paging occasions per paging frame (Ns) and a special WTRU ID. The WTRU, after having acquired the updated contents of the SIBs containing the emergency information, may monitor the special paging occasions for emergency information updates.

The parameters may be contained in a SIB, or in the paging message along with the ETWS-indication. When the network updates the emergency information, it transmits with the P-RNTI on these special paging occasions.

Any form of transmission may be used to transmit any signal described herein, including, but not limited to, for example, multicast or unicast. The term “broadcast” may be defined broadly to include transmit, send, or otherwise transfer a signal. This methods and apparatus disclosed here are not limited to any particular modulation scheme, multiplexing scheme, frequency, or radio technology.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

1. A method, implemented by an evolved Node-B, eNB, of broadcasting an emergency indication during an emergency information broadcast, the method comprising:
broadcasting a paging signal including an emergency indication;
broadcasting a plurality of system information blocks, wherein a first one of the system information blocks includes scheduling information associated with at least a second one of the system information blocks, and the at least second system information block includes emergency information;
determining that a predetermined time period for including the emergency indication in the paging signal has expired;
broadcasting the paging signal without the emergency indication upon the expiration of the predetermined time period; and
rebroadcasting the paging signal including the emergency indication when the emergency information in the at least second information block has been updated.

2. The method as in claim 1 further comprising:
determining the predetermined time period based on a system information modification update period.

3. The method as in claim 1 wherein the emergency indication is an earthquake and tsunami warning service (ETWS) indication.

4-7. (canceled)

8. A method of power savings in a wireless transmit receive unit (WTRU) during an emergency information broadcast, the method comprising:
receiving a paging signal including an emergency indication;
receiving a plurality of system information blocks, wherein a first one of the system information blocks includes scheduling information associated with at least a second one of the system information blocks, and the at least second system information block includes emergency information;
reading the scheduling information in first system information block;
acquiring the at least second system information block based on the scheduling information;
reading the emergency information in the at least second system information block;
receiving the paging signal without the emergency indication upon the expiration of a predetermined time period;
receiving the paging signal including the emergency indication when the emergency information in the at least second information block has been updated;
receiving the plurality of system information blocks, wherein the first system information block includes updated scheduling information associated with at least the second system information block, and the at least second system information block includes updated emergency information;
reading the updated scheduling information in the first system information block;
acquiring the at least second system information block based on the updated scheduling information; and
reading the updated emergency information in the at least second system information block.

9. The method as in claim 8 wherein the predetermined time period is determined based on a system information modification update period.

10. The method as in claim 8 wherein the emergency indication is an earthquake and tsunami warning service (ETWS) indication.

11. (canceled)

12. An evolved Node-B, eNB, configured to broadcast an emergency indication during an emergency information broadcast, the eNB comprising:
a transmitter configured to:
broadcast a paging signal including an emergency indication,
broadcast a plurality of system information blocks, wherein a first one of the system information blocks includes scheduling information associated with at least a second one of the system information blocks, and the at least second system information block includes emergency information,
broadcast the paging signal without the emergency indication upon the expiration of a predetermined time period for including the emergency indication in the paging signal, and
rebroadcast the paging signal including the emergency indication when the emergency information in the at least second information block has been updated; and
a processor configured to determine when the predetermined time period has expired.

13. The eNB as in claim 12 wherein the processor is further configured to determine the predetermined time period based on a system information modification update period.

14. The eNB as in claim 12 wherein the emergency indication is an earthquake and tsunami warning service (ETWS) indication.

15-18. (canceled)

19. A wireless transmit receive unit (WTRU) configured to save power during an emergency information broadcast, the WTRU comprising:
a receiver configured to receive a paging signal including an emergency indication;
the receiver configured to receive a plurality of system information blocks, wherein a first one of the system information blocks includes scheduling information associated with at least a second one of the system information blocks, and the at least second system information block includes emergency information;
a processor configured to read the scheduling information in first system information block;
the processor configured to acquire the at least second system information block based on the scheduling information;
the processor configured to read the emergency information in the at least second system information block;
the receiver configured to receive the paging signal without the emergency indication upon the expiration of a predetermined time period;
the receiver configured to receive the paging signal including the emergency indication when the emergency information in the at least second information block has been updated;
the receiver configured to receive the plurality of system information blocks, wherein the first system information block includes updated scheduling information associated with at least the second system information block, and the at least second system information block includes updated emergency information;
the processor configured to read the updated scheduling information in the first system information block;
the processor configured to acquire the at least second system information block based on the updated scheduling information; and
the processor configured to read the updated emergency information in the at least second system information block.

20. The WTRU as in claim 19 wherein the predetermined time period is determined based on a system information modification update period.

21. The WTRU as in claim 19 wherein the emergency indication is an earthquake and tsunami warning service (ETWS) indication.

22. (canceled)
